(19) United States
(12) Patent Application Publication
(10) Pub. No.: US 2016/0345758 A1
(43) Pub. Date: Dec. 1, 2016

(54) Blanket of Flowers

(71) Applicant: Mark L. Cazares, Sandy, UT (US)

(72) Inventor: Mark L. Cazares, Sandy, UT (US)

(21) Appl. No.: 15/167,379

(22) Filed: May 27, 2016

Related U.S. Application Data
(60) Provisional application No. 62/166,956, filed on May 27, 2015.

(51) Int. Cl. A47G 7/07; A01G 5/00; A61G 17/04

(52) U.S. Cl. CPC A47G 7/07; A61G 17/04; A01G 5/00

(57) ABSTRACT

The present invention is directed to blankets of flowers that can he draped (e.g., over a coffin, casket, table, other structure, etc.). Such blankets of flowers may be employed at funerals, weddings, parties, baptisms, etc. The blanket may negate the need for a vase, and allow striking presentation of cut flowers in a manner not previously available.

### CROSS-REFERENCE TO RELATED APPLICATION

The present application claims the benefit of U.S. Provisional Patent Application Ser. No. 62/166,956, filed May 27, 2015, entitled “BLANKET OF FLOWERS,” the disclosure of which is herein incorporated by reference in its entirety.

### BACKGROUND OF THE INVENTION

1. The Field of the Invention

The present invention is in the field of flower displays.

2. The Relevant Technology

Fresh cut flowers are often displayed in vases or similar containers. There exists a need for alternative display mechanisms.

### BRIEF SUMMARY

The present invention is directed to blankets, pyramids, and other 3-dimensional structures for displaying flowers. For example, a blanket may include a flexible rubber or other elastomeric top layer that can be draped over a surface e.g., a table edge, coffin, etc.). The top layer may be relatively thin and sheet-like, e.g., having a large surface area top/bottom and of a relatively thin thickness, so as to be substantially dimensional (i.e., the thickness is minimal compared to the length and width). The overall blanket itself may also be substantially 2-dimensional (i.e., thickness is minimal compared to length and width). For example, to be substantially 2-dimensional, the thickness of a top layer, or the overall blanket may be less than 5%, less than 3%, or less than 2% of the length and/or width of the layer or blanket. Various dimensions disclosed herein are exemplary of such geometries. Such structures could be termed a blanket of flowers, bed of flowers, or bed of roses (in the case of roses used as the flowers).

In an embodiment, the device for displaying flowers (e.g., fresh cut flowers) may include a flexible, drapable blanket including a rubber or other elastomeric top layer, the top layer being sheet-like and including a plurality of pre-formed holes through which cut flowers may be inserted through the top layer and into a layer of floral foam. In another embodiment, pre-formed holes may not necessarily be provided. For example, the material may have strength and other characteristics that would allow a user to simply press a flower stem, or a proxy thereof (e.g., a dowel) through the top layer, to form a hole. The device may include a layer of floral foam (e.g., OASIS) disposed adjacent to and beneath the top layer, to receive a stein of a cut flower inserted through a pre-formed or other hole of the top layer, and into the floral foam. The rubber or other elastomeric top layer and the layer of floral foam may collectively be flexible and drapable once the layer of floral foam is soaked in water, allowing the device to be draped over a casket, piano, furniture, or other object. The floral foam may soak up the water, so that the water filled device does not leak, or drip during use. A bottom layer may also be provided (e.g., another rubber or elastomeric material) as will be described herein, which may also aid in containing such water that may be present in the device as used.

Another embodiment of the invention may be directed to a pyramid or other 3-dimensional structure for displaying flowers (e.g., fresh cut flowers). Such a device may include one in which each side of the pyramid or other structure includes a rubber or other elastomeric top layer, the top layer being sheet-like and including a plurality of preformed holes through which flowers may be inserted through the top layer and into a layer of floral foam. As described above, in another embodiment, pre-formed holes may not necessarily be provided, but holes may be formed (and placed) as desired by the user using a tool or perhaps even the flower stem to press through the top layer. The device may further include a layer of floral foam (e.g., OASIS) disposed within the interior of the pyramid adjacent to and beneath the top layer of each side of the pyramid or other shaped structure. The layer of floral foam may be configured to receive a stem of a cut flower inserted through the top layer (e.g., through the holes referenced above), into the floral foam.

Another embodiment of the invention may be directed to a device for displaying flowers (e.g., fresh cut flowers) including a flexible, drapable blanket including a rubber or other elastomeric bottom layer and perimeter edge, the bottom layer being sheet-like, and a layer of floral foam (e.g., OASIS) positioned adjacent to and above the bottom layer to receive a stern of a cut flower inserted into the floral foam. The rubber or other elastomeric bottom layer and the layer of floral foam may be flexible and drapable once the layer of floral foam is soaked in water.

Another embodiment for a pyramid structure may include a rubber or other elastomeric bottom layer, including a perimeter edge, where the bottom layer is sheet-like. Each corner of the pyramid may include a rubber or other elastomeric arm that extends towards the center top of the pyramid. A layer of floral foam may be provided within the interior of the pyramid, defining the sides of the pyramid, adjacent to and above the bottom layer of the pyramid. The layer of floral foam may be configured to receive a stern of a cut flower inserted therein, as described above.

These and other advantages and features of the present invention will become more fully apparent from the following description and appended claims, or may be learned by the practice of the invention as set forth hereinafter.

### BRIEF DESCRIPTION OF THE DRAWINGS

In order that the manner which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top plan view of an exemplary blanket of flowers.

FIG. 2 is a cross-sectional view through the blanket of FIG. 1.

FIG. 3 is a close-up cross-sectional view showing how a tie may connect the top layer to a bottom layer of the blanket.

FIG. 4 is a top plan view of a round, circular shaped blanket of flowers.

FIG. 5 is a top plan view of a kidney-shaped blanket of flowers.

FIG. 6A is a top plan view of a pyramid shaped device for holding fresh cut flowers.

FIG. 6B is a side elevation view of the device of FIG. 6A.

FIG. 7 is a cross-sectional view through the device of FIG. 6A.

FIG. 8 is a cross-sectional view through another embodiment of a blanket of flowers, this one including a bottom elastomeric layer, but no top layer.

### DETAILED DESCRIPTION OF THE PREFERRED EMBODIMENTS

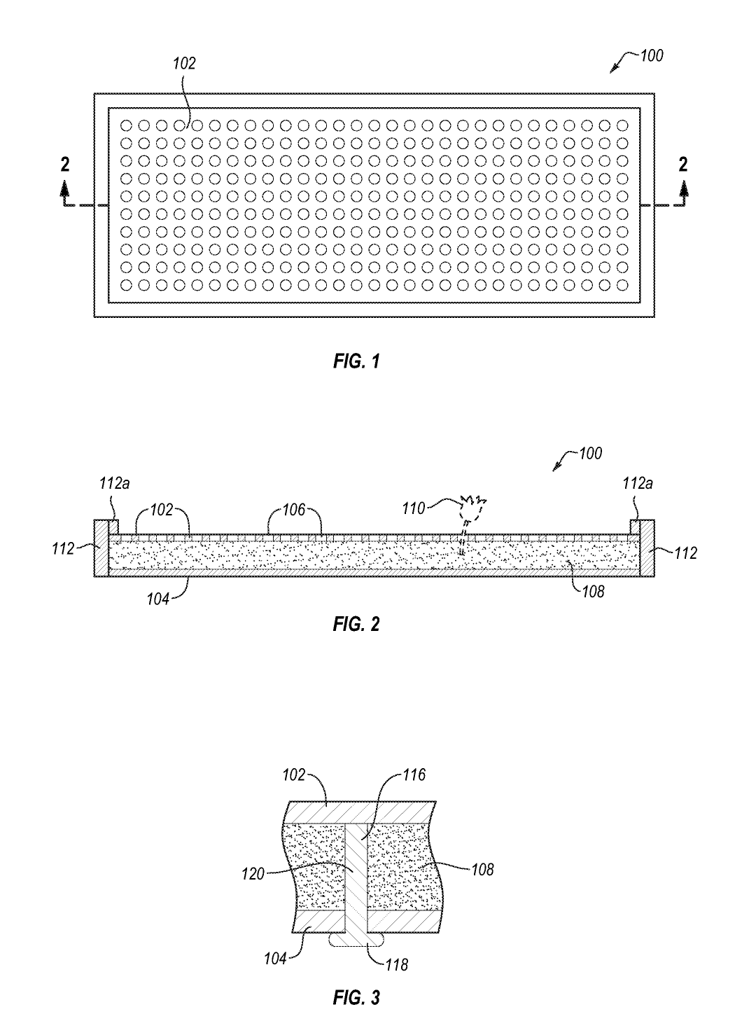

The present invention is directed to blankets, pyramids, and other 3-dimensional structures for displaying flowers. Referring to FIGS. 1-2, a blanket 100 may include a flexible rubber or other elastomeric layer (a top layer 102 or bottom layer 104) that can be draped over a surface (e.g., a table edge, casket, coffin, furniture, etc.). The layers 102, 104 may be relatively thin and sheet-like, e.g., having a large surface area top/bottom and of a relatively thin thickness, so as to be substantially 2-dimensional (i.e., the thickness is minimal compared to the length and width). For example, by sheet-like or substantially 2-dimensional, it is meant that the referred to structure may have a thickness that may be less than 5%, less than 3%, or less than 2%, or less than 1% of the length and/or width of the particular structure (e.g., layer, overall blanket, or the like). Various dimensions disclosed herein and in the provisional application are exemplary of such geometries.

The top layer 102 may include pre-formed holes 106 (e.g., about ¼ inch diameter) through which cut flowers may be inserted. A layer of floral foam 108 (e.g. OASIS) may be disposed beneath and adjacent to the top layer 102 to receive a stem (the stern may be cut to be quite short—sufficiently short so that it does not penetrate the bottom of the floral foam). FIG. 2 shows an exemplary flower 110 inserted into one of holes 106. It will be appreciated that some or all of such holes 106 may be filled with flowers. While the floral foam 108 can be quite rigid and brittle (and fragile) before soaking in water, once soaked, the floral foam 108 becomes flexible and drapable, in conjunction with the thin layer(s) 102, 104 of the rubber or other elastomeric material, so that the entire structure 100 is itself flexible and drapable. The various layers may act as a laminate of the two or more layers together (i.e., so that they all flex and bend together). For example, layer 102, 104, and 108 may flex and bend generally together. Where only one of layers 102 or 104 is provided with layer 108, the two layers (e.g., 104 and 108) may similarly flex and bend together.

If desired the two layers (e.g., 108 and an elastomeric layer 102 or 104) may be attached. to one another (e.g., with an adhesive such as epoxy), or simply mechanically retained relative to one another e.g., in an embodiment the layer of floral foam 108 may be completely encased (other than holes 106) by the elastomeric materials of top layer 102 and a corresponding bottom layer 104 provided below the floral foam 108. The bottom layer 104 may be similar to the top layer 102, but without the pre-formed holes 106. In an embodiment, holes 106 may be die-cut or similarly preformed in top layer 102, but with the plug of material retained within the hole 106. This may allow a user to remove only those plugs of holes 106 desired to be used by inserting a flower stem therein. Of course, in another embodiment, the plugs of such holes may be removed (e.g., all removed). Allowing plugs to remain may reduce evaporation of water from the floral foam 108. The pre-formed holes 106 may be equally spaced, positioned in patterns, equally or differently sized, etc., as desired.

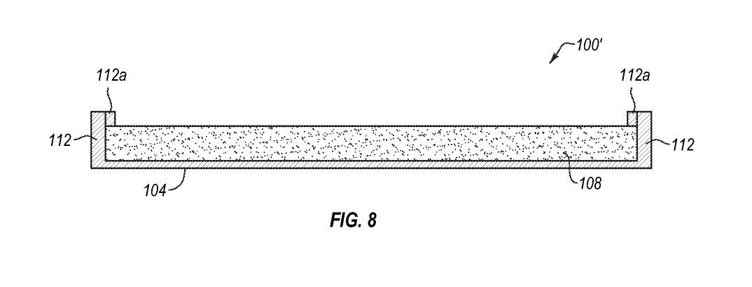

In another embodiment, the floral foam layer 108 may be retained, e.g., within a “cage” of the elastomeric layer (e.g., including overhanging edges 112a of perimeter 112 to trap the floral foam 108 therein, even though it may not be fully encased, for example if there were no top layer in a blanket device 100′, as seen in FIG. 8). Such an embodiment as in FIG. 8 may allow a user to simply push flowers 110 into exposed top of floral foam layer 108, where desired.

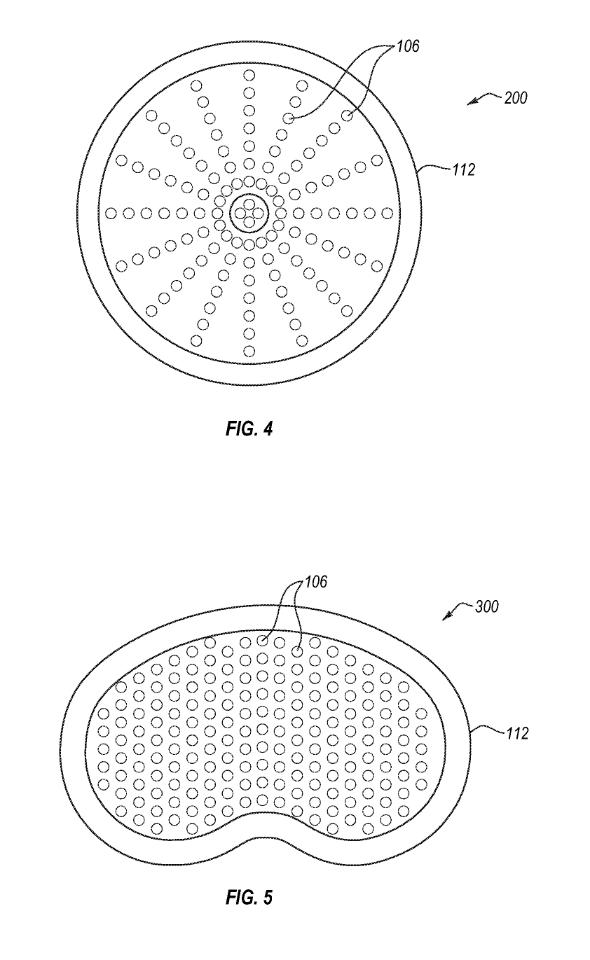

The blanket device may be provided in any desired shape or size (e.g., rectangular, square, circular, oval, triangular, kidney bean shaped, donut shaped, other polygon shaped, other shape defined by straight and/or curved edges, irregular, etc.), In some embodiments, the blanket may be shaped as one or more letters, numbers, other characters, graphics, a silhouette of a recognizable graphic (e.g., Mickey Mouse, etc.), or the like. By way of non-limiting examples, FIG. 1 shows a rectangular shaped blanket 100, FIG. 4 shows a round, circular shaped blanket 200 having some given diameter, and FIG. 5 shows a kidney bean shaped blanket device 300. Any of such variously shaped blanket devices may include a top layer 102, a bottom layer 104, or may omit one of such layers, as described in conjunction with the other Figures. Any of such blanket devices may be sheet-like, generally 2-dimensional, with a thickness dimension that is far less than the width, length, diameter or similar measurements, as described above, so as to be sheet-like.

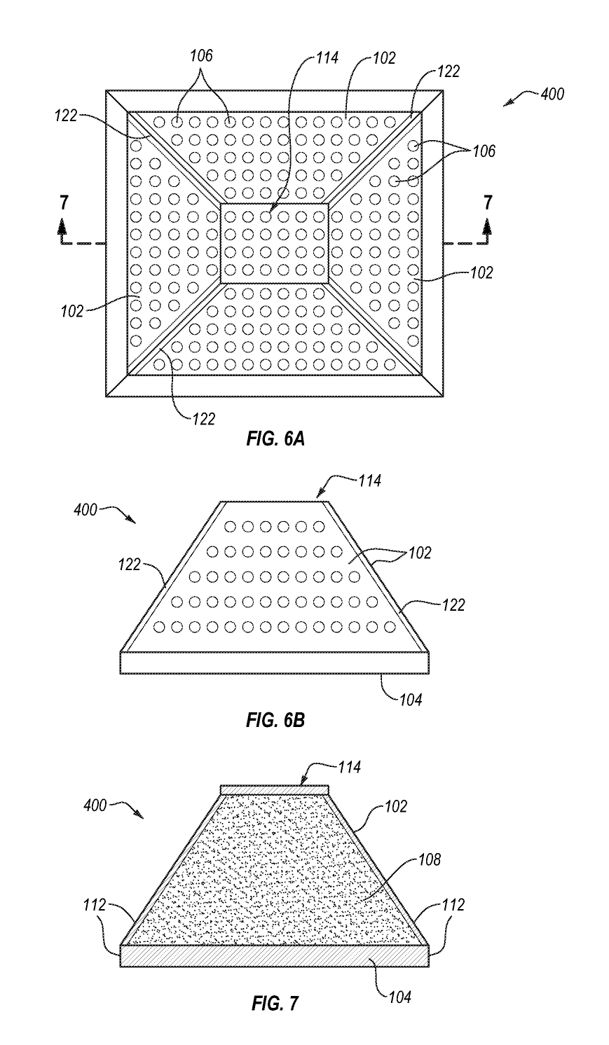

During assembly, the open celled floral foam 108 may be soaked for the necessary time 20-30 minutes). Once prepared, the cut flowers 110 may be inserted through the pre-formed holes 106 (or directly into the floral foam if a top layer of elastomeric material is not necessarily present) so that the bottom of the stem penetrates into the layer of floral foam 108. The flowers may be cut so as to have relatively short stems (e.g., sufficiently short so that they will not penetrate through the bottom of the layer of floral loam 108), For example, for such a blanket, the stems may be less than an inch (e.g., a ½ inch) in length. This may he particularly suitable for smaller to medium size blooms, such as roses, and similarly sized blooms (e.g., about 2 inch diameter or less, or about 1-2 inch diameter blooms).

Where the display is a pyramid device 400 (FIGS. 6A-7), longer stems may be accommodated, given the greater thickness of the layer of floral foam 108 within the interior of the pyramid 400. Somewhat longer stems may also be accommodated, even in a 2-dimensional sheet-like blanket by simply providing the floral foam in a thicker layer, e.g., with a bottom elastomeric/rubber layer 104. The side edges 112 may he covered by the elastomeric layer (e.g., same or similar material to layers 102 and 104). In an embodiment, the perimeter side edge 112 may be integral, e.g., formed as a single piece of material (i.e., seamless) with one or both of layers 102 or 104. The top of the blanket 100, 200, 300 may be open to the floral foam layer 108, which may be somewhat thicker than described relative to an encased embodiment (e.g., 2 inch foam, 3 inch foam, 4 inch foam, 5 inch foam, etc.). Even with such thicker floral foam 108, upon wetting, and with the underlying elastomeric layer 104, the overall structure may be flexible and drapable, if desired, particularly for a thinner foam thickness (e.g., 2 inches or less).

The bottom of the blanket may include a bottom layer 104 of elastomeric/rubber material, sufficiently thick to hold and support the soaked floral foam material 108. The floral foam 108 may he sufficiently thick to retain the needed water for the life of the cut flowers at least about 5 days, 6 days, 7 days, etc.). Of course, additional water could be added after initial set up, if desired, particularly for relatively thinner floral foam configurations.

A pyramid embodiment 400 is shown in FIGS. 6A, 6B and 7. For such a display, the flower holes 106 may be of different sizes (e.g., larger at top, smaller along the bottom and sides of the pyramid), Of course, different sized holes could be provided within any other device as well. The top portion 11.4 of such a pyramid 400 may be removable, allowing easy access to place the floral foam 108 into the interior of the pyramid 400 (e.g., as bricks of floral foam 108). Such bricks may be placed dry, and then soaked. Of course, they could be pre-wetted and placed after soaking.

The pre-formed holes 106 in the top layer for a top portion 114 (removable top portion) of the pyramid 400 may have diameters that are larger than pre-formed holes 106 in the adjacent inclined sides 102 of the pyramid 400 that are lower than the top portion 114. In other words, a top portion 114 of the pyramid 400 may have larger diameter holes than the lower portion holes 106 in inclined sides 102. This may better accommodate larger stem, larger/taller flowers at the top portion 114, and smaller stem, shorter flowers along the lower portion surrounding the top portion 114. Such larger holes could also be placed in the inclined pyramid sides 102, (e.g., with larger holes nearer the top, and smaller holes nearer the bottom), as desired.

The thickness of the top and bottom layers 102, 104 (where a top layer is included) may be similar to one another, and may depend on the overall size of the blanket 100, 200, 300 or pyramid 400. For example, for rectangular (FIG. 1) and circular (FIG. 4) blankets where the length or diameter is about 4 feet or less, the thickness of the top and bottom layers may be about ⅛ inch, or ¼ inch. For 6 or 8 foot sizes (e.g., length. or diameter), the thickness of the elastomeric/rubber layer(s) 102, 104 may be somewhat greater e.g., ⅜ inch), given the significantly increased weight of the overall blanket or pyramid. For example, in any embodiment, the thickness may be from ⅛ inch (0.125 inch) to about ½ inch (0.5 inch), or from ⅛ inch to ⅜ inch (0.375 inch), or any other ranges defined between values disclosed herein.

As shown in FIG. 3, ties 116 may extend from the top layer 102 (or bottom layer 104) through the floral foam layer 108 to help in maintaining the attachment relationship (lamination) between the floral foam and the one or more elastomeric layers. Such ties may bridge between a top layer 102 and bottom layer 104. Such ties 116 may include an enlarged head 118 or washer that engages a portion of the bottom (or top) of the layer 102 or 104 that is enlarged relative to the stem 120 of the tie 116, as seen in FIG. 3.

In another embodiment, for example, for use with silk flowers, there is no need for soaking of the floral foam (OASIS) 108 with water. Such an embodiment may include floral foam 108 (e.g., styrofoam, or another similar foam anchoring material) rather than the OASIS or other floral foam soakable material into which the stems of the silk flowers 110 may be inserted. Such an embodiment will typically weight significantly less, given no need for water. As such, no bottom layer 104 may be needed to cover the bottom of the floral foam 108 (e.g., styrofoam, expanded polystyrene or other expanded foam) to hold in water (as no water is added). In an embodiment, the foam material 108 in such an embodiment may be flexible, and drapable, rather than rigid. In such an embodiment, a top layer 102 of elastomeric material may or may not be present—e.g., the elastomeric material may simply extend around a perimeter edge 112 of the blanket or other device. In such an embodiment, the material and/or thickness of the perimeter edge 112 may be rigid, or more rigid than the bottom layer 104, rather than flexible and elastomeric, if drapability is not needed. Where drapability is not needed, the foam material 108 therein may be rigid, rather than flexible and drapable. Where no top layer 102 is present, the perimeter edge 112 may overhang (e.g., see 112a of FIG. 8) the floral foam 108 or other foam material within the interior of the device. FIG. 8 illustrates an example of a device without any such top layer 102.

When used with fresh cut flowers, the floral foam 108 (e.g., OASIS) may be of a foam material capable of absorbing and soaking up water. When used with silk flowers, the floral foam may be of a foam material that does not readily absorb water, as no water is needed.

Another embodiment of a floral blanket may include an elastomeric or rubber layer (e.g., membrane), where the blanket may be anywhere from 2 inches to 4 inches in thickness. The elastomeric layer may extend around the edge perimeter 112 of the blanket or other device, and may cover the bottom (e.g., layer 104). The elastomeric layer or body structure (e.g., bottom layer 104 and perimeter edge 112) may define a trough into which the floral foam 108 is placed, and which is somewhat less in thickness than the elastomeric rubber edge (see FIG. 8—which shows floral foam 108 recessed below the top of perimeter edge 112). For example, the floral foam 108 may be about ½ inch less in thickness than the height of the elastomeric edge 112, as shown (e.g., about 1.5 inches of foam 108 for a 2 inch thick blanket, about 2.5 inches of foam for a 3 inch thick blanket, etc.). The thicker blanket thicknesses (e.g., about 4 inches) may be particularly suitable for larger blooms (e.g., more than 2 inches in diameter, or length), such as pom poms, gladiolus, bird of paradise, etc.

Such embodiments may still be flexible, and drapable, if desired. For example, the thickness of the floral foam 108, and/or thickness of any underlying rubber bottom layer 104 (and perimeter edge 112) may be sufficiently thin to be flexible, and drapable (e.g., over a casket, piano, other furniture, etc.) during use (e.g., filled with water for live flowers). Such blankets could be attached (e.g., screwed or otherwise) into the casket or other substrate upon which the blanket is placed. The elastomeric/rubber layer 104 could be screwed through, into the substrate for such attachment (e.g., preferably before, although possibly after placement of floral foam layer 108).

In a variation of the embodiment seen in FIGS. 6A-7 another embodiment of a pyramid type configuration 400 may be provided in which the sides (e.g., inclined) of the pyramid 400 do not need to include a top layer of the elastomeric material 102. For example, such a structure would appear as in FIG. 7, but without layer 102. A bottom perimeter edge (analogous to edge 112 that extends partly up sides 102), and a bottom layer 104 of the elastomeric material may be provided. A plurality of arms 122 of the elastomeric material may also be provided along the sides of the pyramid 400. The inclined sides may be open, with exposed, accessible floral foam material 108, into which foam the stems of the desired flowers may be inserted. The perimeter edge 112 and arms 122 help to provide structure and support to the pyramid structure (e.g., aiding in holding the floral foam in place).

Numbers, percentages, or other values stated herein are intended to include that value, and also other values that are about or approximately the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing process, and may include values that are within 10%, within 5%, within 1%, etc. of a stated value. Furthermore, the terms “substantially”, “about” or “approximately” as used herein represents an amount close to the stated amount that still performs a desired function or achieves a desired result. For example, the term “substantially” “about” or “approximately” may refer to an amount that is within 10% of, within 5% of, or within 1% of, a stated amount or value.

Values that are approximately equal to one another may be within 25% of within 10% of, within 5% of or within 1% of one another.

As used in this specification and the appended claims, the singular forms “a,” “an” and “the” include plural referents unless the context clearly dictates otherwise.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A device for displaying fresh cut flowers comprising:
a flexible, drapable, blanket comprising;
a rubber or other elastomeric top layer, the top layer being sheet-like and including a plurality of pre-formed holes through which cut flowers may be inserted through the top layer and into a layer of floral foam;
a layer of floral foam disposed adjacent to and beneath the top layer to receive a stem of a cut flower inserted through a pre-formed hole of the top layer and into the floral foam;
wherein the rubber or other elastomeric top layer and layer of floral foam is flexible and drapable once the layer of floral foam is soaked in water.

2. A device for displaying fresh cut flowers as recited in claim 1, wherein the blanket is of a rectangular or square shape.

3. A device for displaying fresh cut flowers as recited in claim 1, wherein the blanket is of a circular or other round shape.

4. A device for displaying fresh cut flowers as recited in claim 1, wherein the blanket is of a shape selected from the group consisting of donut shaped, kidney bean shaped, triangular shaped, other polygon shaped, shaped like a letter, shaped like a number, shaped like another character, and shaped as a graphic.

5. A device for displaying fresh cut flowers as recited in claim 1, wherein the rubber or other elastomeric top layer has a thickness from about 0.125 inch to about 0.75 inch, from about 0.25 inch to about 0.75 inch, or from about 0.25 to about 0.5 inch.

6. A device for displaying fresh cut flowers as recited in claim 1, wherein the floral foam layer has a thickness from about 0.125 inch to about 1 inch, or from about 0.25 to about 0.75 inch.

7. A device for displaying fresh cut flowers as recited in claim 1, wherein diameter of the pre-formed holes in the top layer is from about 0.125 inch to about 0.5 inch.

8. A device for displaying fresh cut flowers as recited in claim 1, wherein the pre-formed holes in the top layer include holes of different sizes.

9. A device for displaying fresh cut flowers as recited in claim 1, wherein a perimeter edge of the top layer has a thickness that is greater than the adjacent portions of the top layer that are disposed away from the perimeter edge.

10. A device for displaying fresh cut flowers as recited in claim 9, wherein a perimeter edge of the top layer has a thickness that is greater than the combined thickness of the top layer at a location away from the perimeter edge and the layer of floral foam.

11. A device for displaying fresh cut flowers as recited in claim 1, further comprising a rubber or other elastomeric bottom layer disposed on an opposite face of the layer of floral foam, so as to sandwich the layer of floral foam between the top layer and the bottom layer.

12. A device for displaying fresh cut flowers as recited in claim 11, wherein the top layer and the bottom layer have thicknesses approximately equal to one another.

13. A device for displaying fresh cut flowers as recited in claim 1, further comprising a plurality of ties having a top end attached to the top layer, the ties extending through the layer of floral foam, and including an enlarged bottom end head for aiding in retaining the layer of floral foam adjacent the top layer.

14. A device for displaying fresh cut flowers as recited in claim 1, wherein the blanket has a width of about 1 foot to 2 feet and a length from about 2 feet to about 8 feet.

15. A device for displaying fresh cut flowers as recited in claim 1, wherein the blanket is circular and has a diameter from about 1 foot to about 4 feet.

16. A pyramid structure for displaying fresh cut flowers comprising:
each side of the pyramid including a rubber or other elastomeric top layer, the top layer being sheet-like and including a plurality of pre-formed holes through which cut flowers may be inserted through the top layer and into a layer of floral foam;
a layer of floral foam disposed within the interior of the pyramid. adjacent to and beneath the top layer of each side of the pyramid, the layer of floral foam being configured to receive a stem of a cut flower inserted through a pre-formed hole of any of the given top layers and into the floral foam.

17. A pyramid structure for displaying fresh cut flowers as recited in claim 16, wherein the pyramid has a height from about 1 foot to about 4 feet.

18. A pyramid structure for displaying fresh cut flowers as recited in claim 16, wherein a top portion of the pyramid is removable to allow easy loading of the floral foam within the interior of the pyramid during assembly.

19. A pyramid structure for displaying fresh cut flowers as recited in claim 16, wherein the pre-formed holes in the top layer for a top portion of the pyramid have diameters that are larger than pre-formed holes in the top layer for portions of the pyramid that are lower than the top portion.

20. A device for displaying fresh cut flowers comprising:
a flexible, drapable, blanket comprising;
a rubber or other elastomeric bottom layer and perimeter edge, the bottom layer being sheet-like;
a layer of floral foam disposed adjacent to and above the bottom layer to receive a stem of a cut flower inserted into the floral foam;
wherein the rubber or other elastomeric bottom layer and layer of floral foam is flexible and drapable once the layer of floral foam is soaked in water.
